(19) United States
(12) Patent Application Publication
(10) Pub. No.: US 2007/0140829 A1
(43) Pub. Date: Jun. 21, 2007

(54) Modular Hydraulic or Hydroelectric Machine

(76) Inventor: Jean-Christophe MAILLARD DE LA MORANDAIS, Fribourg (CH)

Correspondence Address: BLANK ROME LLP, 600 NEW HAMPSHIRE AVENUE, N.W., WASHINGTON, DC, 20037, US

(21) Appl. No.: 11/554,260

(22) Filed: Oct. 30, 2006

(30) Foreign Application Priority Data
May 6, 2004 (EP) PCT/EP04/50728

(51) Int. Cl. F03B 15/06

(52) U.S. Cl. 415/4.1

(57) ABSTRACT

Low-head modular hydraulic machine (10), usable for generating hydroelectric energy or for directly using the mechanical power. The machine (10) is provided with an adjusting element (50) for setting a stable operating point at constant speed and power, irrespective of the instantaneous power required by the user. The excess power can be used for charging batteries, pumping water, generating hot or cold or simply dissipated in resistances (51). The machine (10) is adaptable to different head heights simply by substituting the water runner (4) with a runner of different pitch or by adjusting manually the blades (5) of the water runner (4). A complete micro-station, constituted of a watertight Container (20) comprising the hydraulic machine (10), call be installed next to a waterfall without a dam being required.

### REFERENCE DATA

The present application is a continuation of International. Patent Application 2004WO-EP050728 (WO05113978) filed on Jun. 6, 2004, the contents whereof are hereby incorporated.

### TECHNICAL FIELD

The present invention concerns a low-head hydraulic machine and notably a modular hydraulic machine of simple construction capable of adapting to a great variety of installations. The inventive machine is used notably, but not exclusively, for generating energy in developing countries.

### STATE OF THE ART

Renewable energies represent a considerable resource and fall perfectly within the framework of the fight against emissions of various pollutants and of CO₂.

Developing countries-generally own abundant and exploitable natural resources such as water and sun. However, renewable energies find it difficult to become widely established when faced for example with small fuel electricity-generating units. Among the reasons for this delay, one can mention the difficulty in dimensioning, producing and maintaining a classic micro-station adapted to the hydraulic conditions of a specific river.

Patent FR1217810 for example describes low-head micro-stations that are easy to build and maintain. The installations are however relatively heavy and require a dam. This type of investment is only justified when voltages of at least a couple of hundreds of kw are required and when a waterfall with sufficient water flow is available.

Small hydroelectric machines are also known that can be installed next to a waterfall or directly in a water bed and that are often constituted of a simple propeller coupled to an electric generator. The efficiency of this type of device is often very low. Furthermore, these machines generally work at highly variable rotation speeds according to the head heights and of the electric power they are called upon to produce. In these conditions, cavitation phenomena can occur and cause these installations to fail.

Another inconvenience of the known devices is that their maintenance is often difficult or even impossible without having to resort to specialized means, which restricts the possibilities of use in developing countries.

One aim of the present invention is to propose a simple and modular hydraulic machine capable of being used for producing energy on a small scale whilst retaining good energy efficiency and a high reliability.

Another aim of the present invention is to propose a low-head hydraulic machine capable of being easily adapted to a variety of hydraulic conditions and notably to several head heights.

Yet another aim of the present invention is to propose a hydraulic micro-station capable of being installed next to a waterfall and without requiring a dam.

Another aim of the present invention is to propose a machine devoid of the disadvantages of the prior art.

These aims are achieved by the device that is the object of the independent claim, the dependent claims indicating optional characteristics of the invention and notably a low-head modular hydraulic machine including:

at least one water runner that can be removed manually, on one axle;

at least one user device driven by said axle for transforming the energy generated by said water runner;

a control module for drawing away part of the energy generated by said water runner and for stabilizing the rotation of said water runner at a predetermined operating speed and force;

said hydraulic machine being adaptable to different head heights by replacing or adjusting said water runner.

The invention derives from the observation that the existing hydroelectric machines are either high-performance machines that are however specially conceived to adapt to a well-defined hydraulic head and water flow condition, or machines that are excessively simple but whose efficiency and reliability in real conditions are very far from optimum performance.

The inventive device can easily adapt to different head heights thanks to the adjusting device that sets, for any level of power required, a constant and stable rotation speed. In these conditions, the machine's efficiency can be optimized simply by selecting a water turbine whose step and diameter are adapted to the sought hydraulic pressure and power.

### DESCRIPTION OF THE FIGURES

FIG. 1 represents a hydraulic machine according to the invention, comprising a removable runner with fixed blades.

FIG. 2 represents a variant embodiment of the hydraulic machine according to the invention, including a removable runner with adjustable blades.

FIG. 3 represents a hydraulic micro-station according to the invention including a hydraulic machine in a watertight container.

FIG. 4 represents diagrammatically a hydroelectric generator according to the invention, wherein the excess power is dissipated in a resistance bank.

FIG. 5 represents diagrammatically a hydraulic machine according to the invention driving a fluids' pump.

FIG. 6 represents diagrammatically a hydroelectric generator according to the invention, wherein the excess power is used in an auxiliary use device.

FIGS. 7 and 8 represent diagrammatically a hydroelectric generator according to another aspect of the invention.

### DETAILED DESCRIPTION OF THE INVENTION

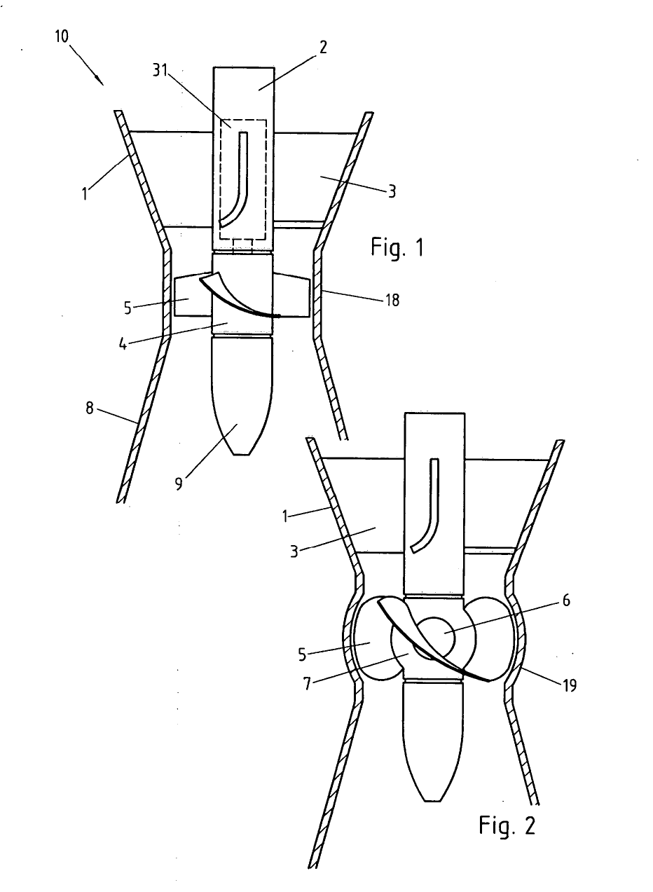

With reference to FIG. 1, a first embodiment of the invention is now described. The hydraulic machine 10 comprises upstream a converging funnel 1 enclosing inside it a distribution gate 3. The distribution gate includes in this embodiment four fixed inclined curved surfaces designed to impress a circulation movement to the water descending inside the funnerl 1. Inside the funnel is also located the electric generator 31 protected by a watertight casing 2. The generator 31 is driven by a runner 4 with blades fastened in a removable fashion directly onto its axle. The conical hub 9 and the draft tube 8 ensure the water drainage downstream.

With an aim of simplifying the construction and feeding, the electric generator 31 is preferably an asynchronous electric motor of standard type coupled to a suitable capacitor bank. The dimensions of the machines depend on the diameters of these standardized motors. The generated electric power can vary between 100 Watts and 30 Kilowatts approximately.

It is possible to use other types of motors: for example a permanent magnet generator or a variable reluctance generator or even, in certain cases, a car alternator or any other known electric generator.

The bladed runner 4 includes in this embodiment of the invention four blades 5 having a fixed inclination and a constant or nearly constant chord. This arrangement allows a simple cylindrical section 18 to be used around the runner 4 with a moderate loss of efficiency relatively to the optimum geometry.

The regulating device of the working point is now described with reference to FIG. 4. The runner 4 drives in rotation the generator 31 that produces at the electric terminals 32 an alternating voltage of 240V and 50 Hz for example. An electronic adjusting circuit 50 measures the runner's rotation speed, for example by frequency measurement, and dissipates a certain quantity of energy in the resistance 51 when the rotation speed exceeds the predetermined normal speed. In this manner, the runner always rotates at the nominal speed and power irrespective of the power drawn at the exit terminals 32.

Preferably, the circuit 50 also integrates functions of protection against over-voltages and overloads and of differential protection of the users.

Once the rotation speed of the runner 4 has been determined, the hydraulic parameters can be optimized simply by selecting the inclination of the blades 5 according to the available head height and thus the water pressure.

Since the blades' inclination in this embodiment is fixed, the optimization is performed by selecting the best suited runner from a set of pre-adjusted runners.

To this effect, the runner 4 is mounted on the axle of the motor 31 so as to make it easy to replace with hand tools. This arrangement allows the runner to be substituted fast also to remedy failures and to gain access to the motor 31.

For a given nominal power, and thus a determined diameter of the machine, the optimum pitch of the blades 5 depends only on the head height. It is thus possible to gather this information in a simple table, for example, to allow the users to select the optimum runner according to the desired power and to the available head height, without any computation being necessary.

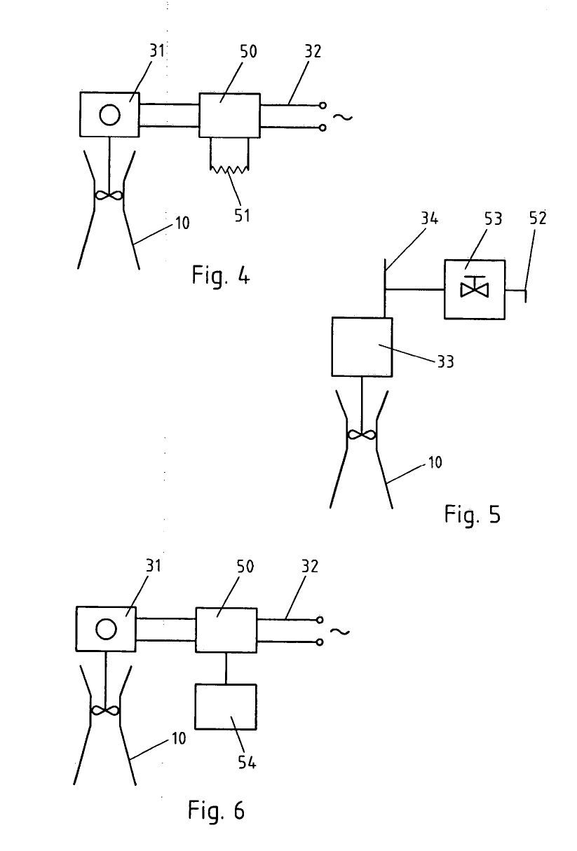

In a later embodiment of the invention, represented in FIG. 5, the runner 4 directly drives a fluids' pump 33, for example a pump for raising the water necessary for irrigation or for pumping drinking water. This variant embodiment of the invention thus uses directly the mechanical energy generated by the runner 4 without electric conversion. In this case, the regulation of the working point at constant speed is performed by a hydrostatic valve 51 that deviates part of the pumped water towards the return conduit 52. The pump 33 thus operates at constant pressure and output independently from the quantity of water drawn at the exit 34 of the pump.

In other embodiments, not represented, the present invention allows the mechanical energy produced by the runner 4 to be used directly for other purposes, for example the runner 4 could directly drive a compressor or a heat pump for generating hot or cold.

In a later embodiment represented in FIG. 6, the excess electric power generated by a generator 31 is used in a use or storing device 52 instead of being simply dissipated. The power that is not immediately required can be used for example for charging batteries, for actuating an electric water pump, for feeding high-efficiency light bulbs or modules or for the static production of hot or cold.

Another embodiment is now described in relation to FIG. 2. In this variant embodiment, the runner 7 includes blades 5 with adjustable inclination. Each blade is fastened to the runner 7 by a turning plate 6. An interior mechanism, not represented, allows the blades 5 to be rotated simultaneously and blocked at the desired pitch. The spherical section 19 allows the blades 5 to be inclined variably with a minimal clearance.

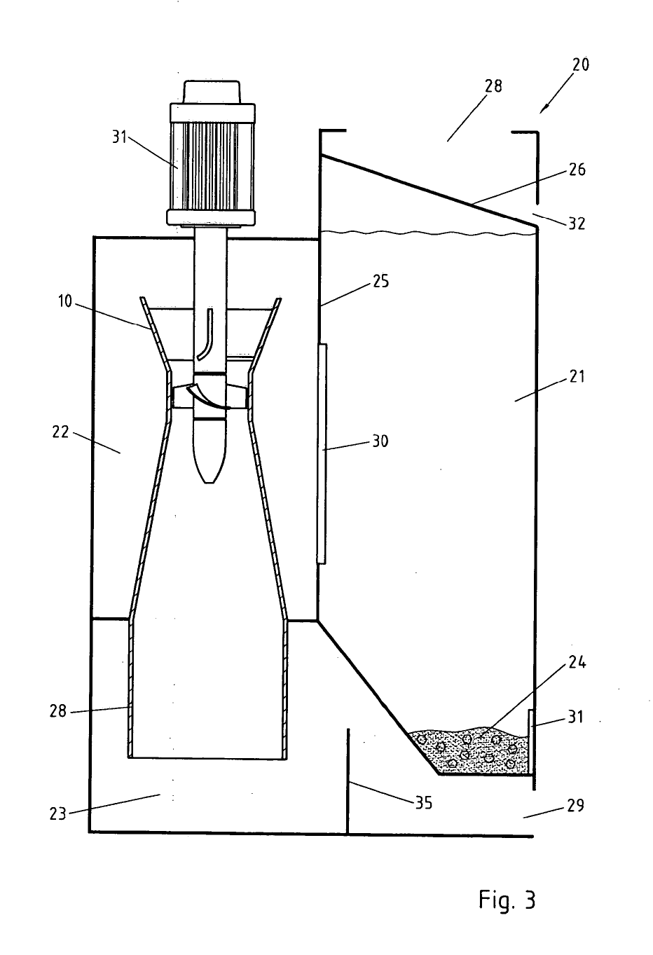

FIG. 3 represents another embodiment of the invention wherein a hydraulic machine 10 is integrated in a watertight container 20 to make a modular hydraulic micro-station.

The container 20 is divided into two chambers 21 and 22 by a vertical partition wall 25. The upstream chamber 21 and the downstream chamber 22 communicate through a sand filter 30 fastened to the partition wall 25. The filter 30 is a strainer or a fabric filter or another filter capable of retaining sand and sediments and preventing them from coming into the hydraulic machine 10.

The container 20 is preferably installed close to the waterfall and receives the water from a collecting installed upstream of the fall through the inlet opening 28. Preferably, the container 20 also includes a filtering screen 26 for retaining coarse solid bodies such as branches, leaves and stones. A drainage orifice 32 allows for the material retained by the screen 26 to be continuously evacuated.

The chamber 21 also allows the sediments 24 to decant. The sand and gravel 24 accumulate at the bottom of the chamber 21 and can be eliminated by a purging gate 31.

The downstream chamber 22 contains the hydraulic machine and serves as siphon to prevent the ingress of air bubbles in the machine 10. A valve, not represented, is provided for priming the siphon. The generator 31 can be lodged at the top and outside the water, as represented in FIG. 3, or inside a submerged watertight cover, as in FIG. 1, depending on the required power and the size of the generator.

The water coming out from the hydraulic machine 10 through the exit conduit 28 travels through the lower chamber 23 and exits through the opening 29. The weir 35 prevents the second chamber 22 from emptying if the water flow is interrupted. Depending on the available head height, the exit conduit can be elongated downwards in order to increase the hydraulic power. In this case, it goes through the bottom of the container 20 through an opening provided to this effect. The used water can be returned to the original stream or river, or used for other purposes, for example for irrigation.

Optionally, a hydraulic actuator, not represented, sensitive to the pressure variation of the chambers 21 and 22 triggers the opening of the purging gate 31, which has the effect of emptying the sediments and the water contained in the chamber 21 and then 22, which causes the sand filter 30 to be cleaned by inversion of the water current. The purging gate closes automatically as soon as the purging cycle is finished; the machine is also primed as soon as the chambers 21 and 22 are automatically filled.

Preferably, the container 20 is made by grinding/milling of an appropriate plastic material, for example ABS (acrylonitrile-butadiene-styrene plastic). In the case of a small series, it could also be made of resin reinforced with glass fibers or by another known process.

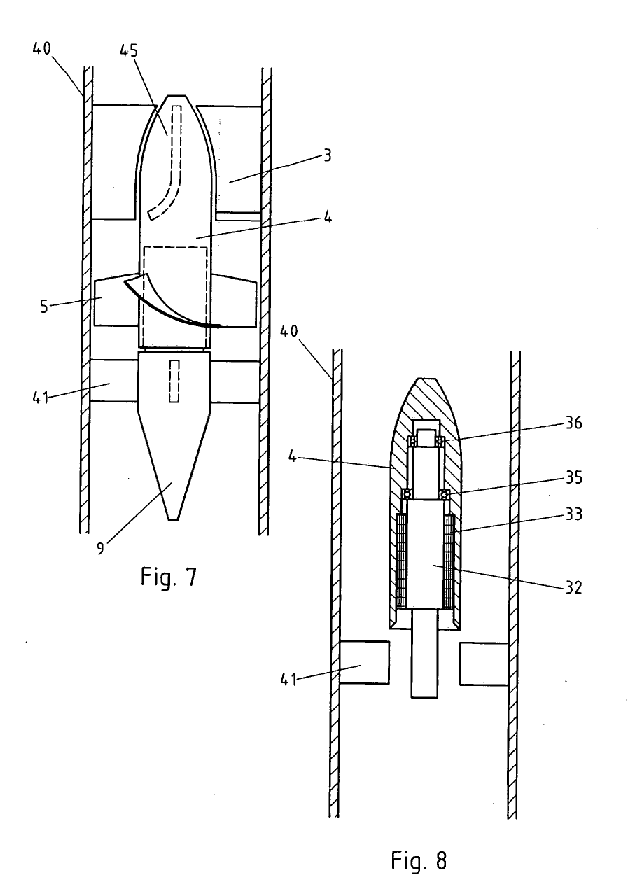

Another variant embodiment of the present invention is now described with reference to FIGS. 7 and 8. In this variant, the machine is lodged inside a straight section 40. The water runner 4 is upstream relatively to the supporting structure 41. The water runner has a conical hub 45 upstream, surrounded by the fixed blades of the diffuser 3. The electric generator is located inside the runner 4 and is composed of a coiled stator 32 fixedly united with the fixed axle 38, surrounded by a permanent magnet rotor 33 fixedly united with the runner 4.

The runner 4 is free to turn around the fixed axle thanks to two ball bearings 35 and 36. Advantageously, the runner 4 is placed or clicked onto the axle 38 so as to be easily removable without need for tools, if necessary. The water's gravity and dynamic pressure are sufficient to keep the runner 4 in place during normal operation of the hydraulic machine.

Optionally, the inside volume of the runner 4 can be made watertight by a flexible gasket or another sealing device. However, the inventive machine could also be made in a non-watertight version in order to facilitate its making and its disassembling. In this case, the air present inside the runner 4 prevents water from entering. Grooves diverging outwards provided between the permanent magnets 33 make it easier to expel water through centrifugal effect. In this embodiment, the coiled stator is preferably: covered in impermeable resin to protect it from water projections and the ball bearings 35 are also protected by greasing. Optionally, it is also possible to use sealed ball bearings.

The inventive micro-station can be adapted for a large variety of hydraulic conditions simply by selecting the dimension, thus the power, of the machine and the pitch of the bladed runner, as already explained. Advantageously, the station can be simply installed close to a river without a dam or considerable civil engineering works being required.

1. Low-head modular hydraulic machine including:
at least one water runner that can be removed manually, on one axle;
at least one user device driven by said axle for transforming the energy generated by said water runner;
a control module for drawing away part of the energy generated by said water runner and for stabilizing the rotation of said water runner at a predetermined operating speed and force;
characterized in that said hydraulic machine can be adapted to different head heights by replacing or adjusting said water runner.

2. The modular hydraulic machine of claim 1, wherein said user device includes an electric generator.

3. The modular hydraulic machine of claim 2, wherein said control module acts on the electric current generated by said generator.

4. The modular hydraulic machine of claim 1, wherein the energy drawn by said control module is used for at least one of the following uses: charging batteries, dissipation in discharge resistances, generation of hot or cold, pumping fluids, pumping drinking water.

5. The modular hydraulic machine of claim 1, wherein said user device includes a fluids' pump.

6. The hydraulic machine of claim 5, wherein said control module acts on the flow drawn from said pump.

7. The modular hydraulic machine of claim 1, wherein said user device includes a fluid compressor designed to generate cold.

8. Modular hydraulic machine according to claim 1, wherein said user device includes a hot water and steam generator.

9. The modular hydraulic machine of claim 1, wherein said control module keeps said operating speed and power constant without variation in the water flow of said water runner.

10. Hydraulic micro-station, for an installation with or without a dam, including a watertight container, divided in a first chamber and a second chamber through a partition wall; said container including:
an inlet opening for bringing the water into said first chamber;
a filtering screen for retaining coarse solid bodies coming from the inlet conduit, and a decanting zone in said first chamber;
a filter allowing said first chamber and second chamber to communicate;
a hydraulic machine according to claim 1, lodged in said second chamber.

11. The hydraulic micro-station of claim 10, including in said first chamber, a purging gate actuated automatically by an actuator sensitive to the pressure variation between said first and second chamber, said purging gate allowing sediments to be eliminated from said decanting zone.
